(19) United States
(12) Patent Application Publication
(10) Pub. No.: US 2016/0086142 A1
(43) Pub. Date: Mar. 24, 2016

(54) INFORMATION PROVISION APPARATUS, INFORMATION PROVISION METHOD, AND STORAGE MEDIUM

(71) Applicant: YAHOO JAPAN CORPORATION, Tokyo (JP)

(72) Inventors: Takashi ANDO, Tokyo (JP); Hidehito GOMI, Tokyo (JP); Hiroshi OTA, Tokyo (JP); Takayuki TSUCHIYA, Tokyo (JP)

(21) Appl. No.: 14/842,367

(22) Filed: Sep. 1, 2015

(30) Foreign Application Priority Data
Sep. 19, 2014 (JP) 2014-190687

(51) Int. Cl. G06Q 20/10; G06Q 30/06

(52) U.S. Cl. CPC G06Q 20/10; G06Q 30/0639

(57) ABSTRACT

An information provision apparatus according to an embodiment includes a detection information acquisition unit, a user information acquisition unit, and an information provision unit. The detection information acquisition unit acquires information on an identification target provided at a place corresponding to a business operator from a user terminal that detects the information on the identification target. The user information acquisition unit acquires, among pieces of user information corresponding to the user terminal that detects the information on the identification target, user information corresponding to business operator information on the business operator associated with the place corresponding to the information on the identification target detected by the user terminal. The information provision unit provides information to the user terminal that detects the information on the identification target, based on the user information acquired by the user information acquisition unit.

### CROSS-REFERENCE TO RELATED APPLICATION

The present application claims priority to and incorporates by reference the entire contents of Japanese Patent Application No. 2014-190687 filed in Japan on Sep. 19, 2014.

### BACKGROUND OF THE INVENTION

1. Field of the Invention

The present invention relates to an information provision apparatus, an information provision method, and a storage medium.

2. Description of the Related Art

Conventionally, there have been proposed techniques for transmitting information on products provided by stores and advertisement information of the stores through wireless communications to electronic devices held by users who have entered predetermined areas (for example, see Japanese Patent Application Laid-open No. 2002-216251 and Japanese Patent Application Laid-open No. 2003-288289).

The conventional techniques make it possible to provide information on products and advertisements of stores. However, such store information is indiscriminately distributed to all applicable users, and thus may not be suited to some of the users.

### SUMMARY OF THE INVENTION

An information provision apparatus according to an embodiment includes a business operator information storage unit, a user information storage unit, a detection information acquisition unit, a business operator information acquisition unit, a user information acquisition unit, and an information provision unit. The business operator information storage unit stores pieces of business operator information as information on a business operator. The user information storage unit stores pieces of user information as information on a user of a user terminal. The detection information acquisition unit acquires information on an identification target provided at a place corresponding to the business operator from the user terminal that detects the information on the identification target. The business operator information acquisition unit acquires, from the business operator information storage unit, business operator information corresponding to the business operator associated with the place corresponding to the information on the identification target detected by the user terminal. The user information acquisition unit acquires, among the pieces of user information stored in the user information storage unit and corresponding to the user terminal that detects the information on the identification target, user information corresponding to the business operator information acquired by the business operator information acquisition unit. The information provision unit provides information to the user terminal that detects the information on the identification target, based on the user information acquired by the user information acquisition unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is an illustrative diagram (No. 1) of an information provision process according to an embodiment;

FIG. 1B is an illustrative diagram (No. 2) of the information provision process according to the embodiment;

FIG. 2 is a diagram illustrating a specific configuration example of an information provision system according to the embodiment;

FIG. 3 is a diagram illustrating a configuration example of an information provision apparatus according to the embodiment;

FIG. 4 is a diagram illustrating an example of a business operator information table;

FIG. 5 is a diagram illustrating an example of a user information table;

FIG. 6 is a diagram illustrating a configuration example of a user terminal according to the embodiment;

FIG. 7 is a diagram illustrating an example of a display screen of the user terminal;

FIG. 8 is a diagram illustrating an example of the display screen of the user terminal;

FIG. 9 is a diagram illustrating an example of the display screen of the user terminal;

FIG. 10 is a flowchart illustrating information processing by the information provision apparatus according to the embodiment;

FIG. 11 is a flowchart illustrating information processing by the user terminal according to the embodiment; and

FIG. 12 is a hardware configuration diagram illustrating an example of a computer that implements the functions of the information provision apparatus.

### DETAILED DESCRIPTION OF THE PREFERRED EMBODIMENT

Hereinafter, an embodiment of an information provision apparatus, an information provision method, a storage medium, and an information provision system according to the present application will be described in detail with reference to the accompanying drawings. The information provision apparatus, the information provision method, the storage medium, and the information provision system according to the present application are not limited to the embodiment.

1. Information Provision Process

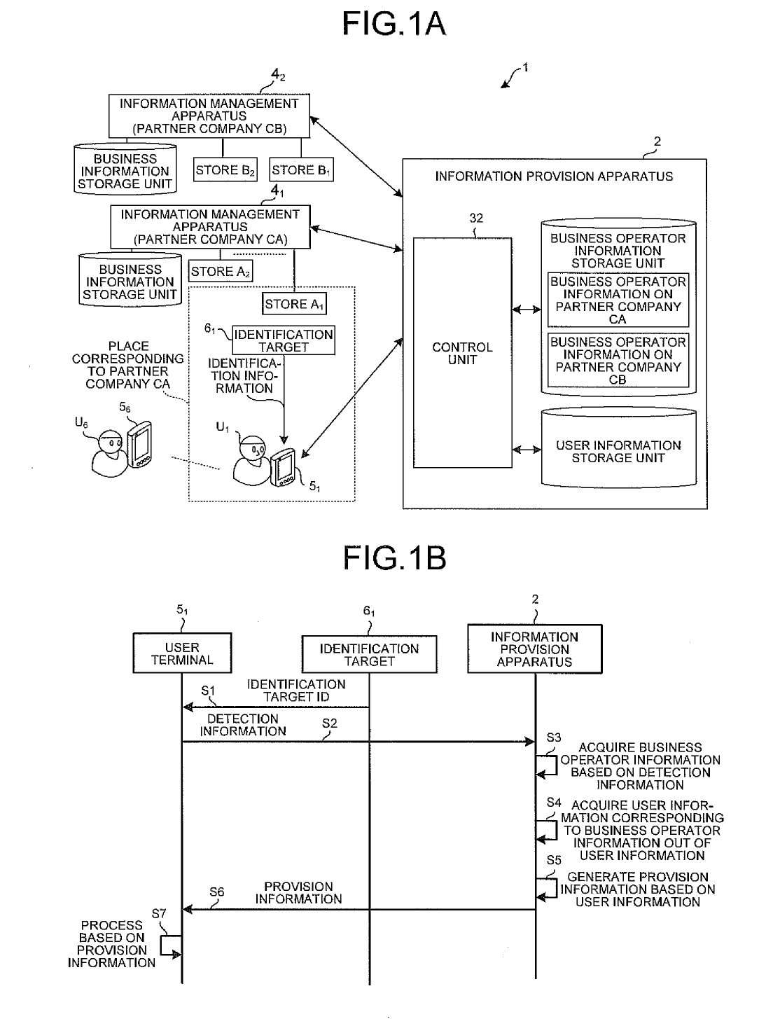

First, the information provision process according to an embodiment will be described. FIGS. 1A and 1B are illustrative diagrams of information provision processes according to the embodiment. In the embodiment, an information provision system performs the information provision processes.

As illustrated in FIG. 1A, an information provision system 1 includes an information provision apparatus 2 and information management apparatuses 4₁ and 4₂. The information provision apparatus 2 is managed and operated by an information provider, for example. The information management apparatuses 4₁ and 4₂ (hereinafter, also referred to collectively as information management apparatus 4) are managed and operated by partner companies CA and CB (hereinafter, also referred to collectively as partner company C), respectively.

The partner company C is a business operator having a partnership contract with the information provider, and, for example, is a business operator providing its products and services at stores. The partner company CA is a business operator providing its products and services at stores A₁ and A₂. The partner company CB is a business operator providing its products and services at stores B₁ and B₂. The partner company C is not limited to a distributor but may be an entertainment business operator holding concerts and sports events, or may be a commercial space operator managing hotels, hair salons and barber shops, hospitals, movie theaters, or leisure complexes.

User terminals 5₁ to 5₆ illustrated in FIG. 1A are user terminals held by users U₁ to U₆ that enter the stores and facilities of the partner companies C (hereinafter, also referred to collectively as stores) and/or purchase products and services at the stores of the partner companies C. In the fallowing description, the user terminals 5₁ to 5₆ will also be referred to collectively as user terminal 5, the users U₁ to U₆ will also be referred to collectively as user U. The stores and facilities of the partner companies C will also be called business places.

The information provision apparatus 2 has a user information storage unit that stores pieces of user information on the user U of the user terminal 5 (hereinafter, referred to as user information). The user information stored in the user information storage unit includes, for example, the gender, age, and address of the user U, and information indicative of payment methods usable by the user U. The user information is stored in the user information storage unit in association with identification information on the user terminal 5 (hereinafter, referred to as terminal ID).

The information management apparatus 4₁ has a business operator information storage unit that stores business operator information related to the partner company CA, and the information management apparatus 4₂ has a business operator information storage unit that stores business operator information related to the partner company CB. The information provision apparatus 2 acquires the business operator information on the partner companies CA and CB from the information management apparatuses 4₁ and 4₂, and stores the same in the business operator information storage unit. The business operator information includes, for example, information indicative of payment methods usable at the stores of the partner company C.

Identification targets are provided at places corresponding to the partner company C. For example, an identification target 6₁ is provided at the store A₁ illustrated in FIG. 1A. Although not illustrated in the drawings, identification targets 6₂, 6₃, and 6₄ are provided at the stores A₂, B₁, and B₂. Hereinafter, the identification targets 6₁ to 6₄ will also be referred to collectively as identification target 6.

The identification target 6 may be, for example, a wireless communication device performing communications via a wireless LAN (Local Area Network), NFC (Near Field Communication), and Bluetooth (registered trademark), or a one-dimensional barcode or second-dimensional barcode (hereinafter, referred to simply as barcode).

The user terminal 5 detects the identification information on the identification target 6 (hereinafter, referred to as identification target ID), and transmits the same to the information provision apparatus 2. When the identification target 6 is a wireless communication device, for example, the user terminal 5 detects the identification target ID transmitted from the wireless communication device, and transmits the same to the information provision apparatus 2.

When the identification target 6 is a barcode, the user terminal 5 converts the image of the barcode shot by the imaging unit into text information, detects some or all parts of the text information as an identification target ID, and transmits the same to the information provision apparatus 2. In the following description, the place corresponding to the identification target ID where the user U has entered will also be referred to as user-entered place, and the user U of the user terminal 5 having transmitted the identification target ID of the identification target 6 will also be referred to as entering user U.

When acquiring the identification target ID of the identification target 6 from the user terminal 5, a control unit 32 of the information provision apparatus 2 then acquires the business operator information on the partner company C according to the place corresponding to the identification target ID from the business operator information storage unit. Then, the control unit 32 acquires from the user information storage unit, among the pieces of user information corresponding to the user terminal 5 having transmitted the identification target ID, the user information corresponding to the business operator information acquired from the business operator information storage unit.

For example, the business operator information on the partner company C according to the place corresponding to the identification target ID is information indicative of payment methods usable at the stores of the partner company C. The payment methods include, for example, credit card payment, convenience-store payment, e-money payment, and the like. The payment methods also include the types of credit cards (for example, international credit card brands).

In this case, the control unit 32 acquires, among the pieces of user information corresponding to the user terminal 5 having transmitted the identification target ID, information on the payment methods usable by the user U that are identical with the payment methods usable at the stores of the partner company C, as information on the payment methods usable at the stores of the partner company C. Accordingly, the control unit 32 can acquire, among the payment methods usable by the user U of the user terminal 5 having transmitted the identification target ID, the information indicative of the payment methods usable at the stores of the partner company C.

For example, the payment methods usable at the stores of the partner company C according to the place corresponding to the identification target ID include credit card payment, and the usable international credit card brands are brands A1, A3, A4, and A5. In addition, for example, the payment method usable by the user U of the user terminal 5 having transmitted the identification target ID is credit card payment, and the usable international credit card brands are brands A1, A2, and A3. In this case, the control unit 32 acquires the information indicative of the credit card payment with the international brands A1 and A3.

Based on the thus acquired information, the control unit 32 provides information to the user terminal 5 that detects the information on the identification target 6. For example, the control unit 32 generates information to be displayed at the user terminal 5 based on the acquired information, and provides the information to the user terminal 5 that detects the information on the identification target 6. Accordingly, the user terminal 5 can display, among the payment methods usable by the user U, the information indicative of the payment methods usable at the store of the partner company C where the user U has entered, for example.

The control unit 32 also can generate information for activating a payment function included in the user terminal 5 based on the acquired information, and provide the same to the user terminal 5 that detects the information on the identification target 6. Accordingly, when the user terminal 5 has the payment function, the user terminal 5 can dynamically activate the payment function at the user-entered place. The payment function of the user terminal 5 is the function of making e-money payment or credit card payment from the user terminal 5 to the device at the store, for example.

One example of a process performed by the user terminal 5₁ when the user U₁ of the user terminal 5₁ has entered the store A₁ will be described with reference to FIG. 1B.

When the user U₁ of the user terminal 5₁ has entered the store A₁, the user terminal 5₁ acquires the identification target ID of the identification target 6₁ from the identification target 6₁ provided at the store A₁ (step S1). The user terminal 5₁ transmits detection information including the acquired identification target ID of the identification target 6₁ and the terminal ID of the user terminal 5₁ to the information provision apparatus 2 via a communication network (step S2).

When acquiring the detection information from the user terminal 5₁, the control unit 32 of the information provision apparatus 2 then acquires the business operator information corresponding to the identification target ID included in the detection information from the business operator information storage unit (step S3). The control unit 32 also acquires, among the pieces of user information stored in the user information storage unit and corresponding to the terminal ID included in the detection information, the information corresponding to the business operator information acquired at step S3 (step S4).

Based on the information acquired at step S4, the control unit 32 generates provision information for the user terminal 5₁ that detects the identification target ID (step S5), and transmits the provision information to the user terminal 5₁ (step S6). The control unit of the user terminal 5₁ performs a process based on the provision information transmitted from the information provision apparatus 2 (step S7).

Accordingly, the user terminal 5₁ can display, among the pieces of user information on the entering user U₁, the information corresponding to the business operator information of the store A₁, for example, and therefore the user terminal 5₁ can provide the user information corresponding to the store A₁ to the entering user U₁. As described above, the information provision process according to the embodiment makes it possible to provide information suited to the user U according to the place corresponding to the business operator.

2. Configuration of the Information Provision System

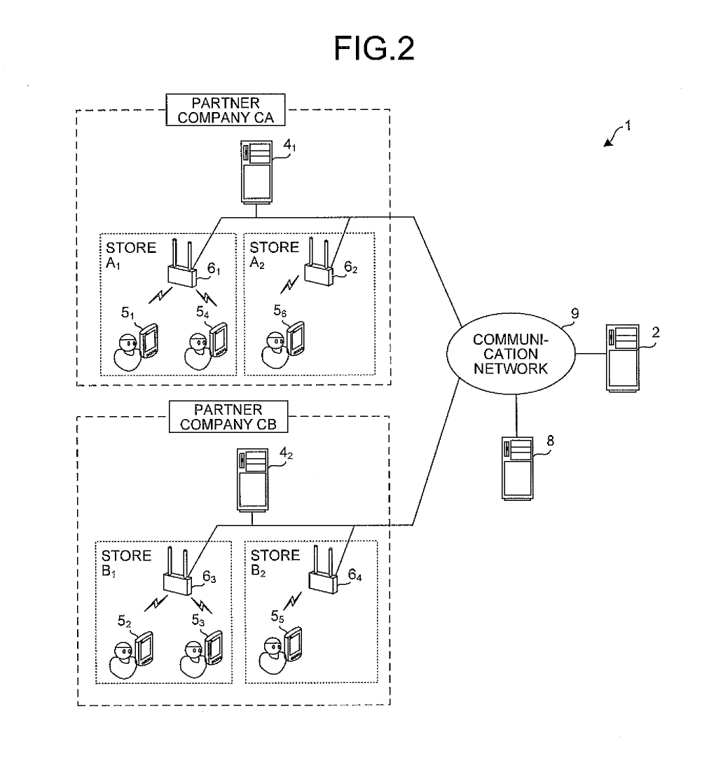

A configuration example of the information provision system 1 according to the embodiment will be described with reference to FIG. 2. FIG. 2 is a diagram illustrating a configuration example of the information provision system 1 according to the embodiment.

As illustrated in FIG. 2, the information provision system 1 includes the information provision apparatus 2, the information management apparatuses 4₁ and 4₂, the user terminals 5₁ to 5₆, the identification targets 6₁ to 6₄, and a site server 8.

The information provision apparatus 2, the information management apparatus 4, the user terminals 5₁ to 5₆, and the site server 8 are communicably connected to each other via a communication network 9. The communication network 9 is a WAN (Wide Area Network) such as the Internet, for example.

In the example of FIG. 2, the two partner companies CA and CB are taken. However, the number of the partner companies C may be one or three or more. One or more identification targets 6 are provided at each of stores of the partner company C. In the example of FIG. 2, the identification targets 6₁ and 6₂ are provided at the stores A₁ and A₂ of the partner company CA, and the identification targets 6₃ and 6₄ are provided at the stores B₁ and B₂ of the partner company CB.

The user terminal 5 is a terminal device with the wireless WAN communication function, for example, such as a smartphone or a PC (personal computer) that can communicate with a wireless WAN base station (not illustrated). The wireless WAN base station is connected to the communication network 9. The user terminal 5 may be connected to the communication network 9 through wired communications instead of wireless communications.

The identification target 6 may be a communication device performing communications via a wireless LAN, NFC, Bluetooth (registered trademark), for example, or may be a marker such as a barcode or a pre-decided sign. The communication area for NFC covers about one meter to several centimeters. The NFC may be in conformity with Felica or ISO/IEC14443 (MIFARE), for example.

The identification target 6 may not necessarily perform communications by radio waves but may perform communications by infrared rays, visible light, sound waves, human body, or wire lines, for example. The human body communications may be performed over a BAN (Body Area Network). The identification target 6 may not be connected to the communication network 9 or may not be limited to the example of FIG. 2.

The site server 8 is managed and operated by the information provider to, in response to access from the user terminal 5 via the communication network 9, provide web pages in various categories to the user terminal 5 via the communication network 9, for example. The user ID of the user U is a login ID for the site server 8, for example.

The configurations of the information provision apparatus 2 and the user terminal 5 will be described below in this order.

3. Information Provision Device

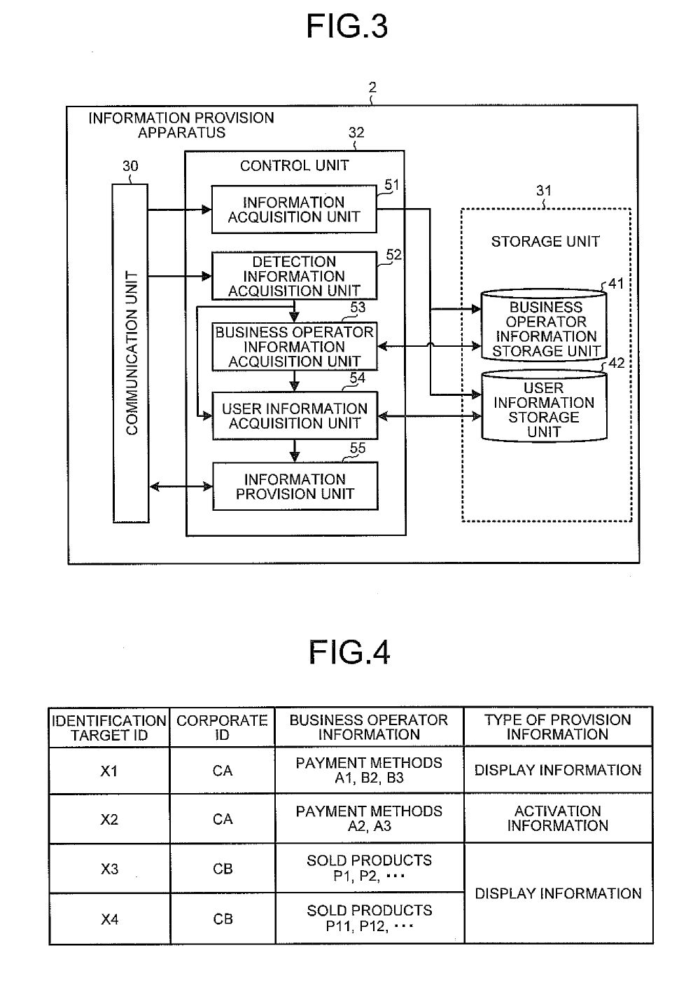

FIG. 3 is a diagram illustrating a configuration example of the information provision apparatus 2. As illustrated in FIG. 3, the information provision apparatus 2 has a communication unit 30, a storage unit 31, and the control unit 32.

The storage unit 31 has a business operator information storage unit 41 and a user information storage unit 42. The control unit 32 has an information acquisition unit 51, a detection information acquisition unit 52, a business operator information acquisition unit 53, a user information acquisition unit 54, and an information provision unit 55.

The communication unit 30 is an interface such as an NIC (Network Interface Card), for example. The control unit 32 exchanges various kinds of information with the information management apparatus 4 or the user terminal 5 via the communication unit 30 and the communication network 9. The business operator information storage unit 41 and the user information storage unit 42 are storage devices such as a hard disc, a RAM, and a semiconductor memory device including a flash memory.

When the programs stored in the internal storage device are executed by the internal CPU or MPU in a RAM as a working area, the control unit 32 performs the functions as the information acquisition unit 51, the detection information acquisition unit 52, the business operator information acquisition unit 53, the user information acquisition unit 54, and the information provision unit 55. The configuration of the control unit 32 is not limited to this configuration but may be another one as far as the control unit 32 performs information processing described later.

3.1. Information Acquisition Unit

The information acquisition unit 51 acquires the business operator information held by the plurality of partner companies CA and CB from the information management apparatuses 4₁ and 4₂, and stores the same in the business operator information storage unit 41. The information acquisition unit 51 also acquires the user information held by the plurality of partner companies CA and CB from the information management apparatuses 4₁ and 4₂, and stores the same in the user information storage unit 42. The user information held by the partner companies CA and CB includes purchase histories described later, for example.

FIG. 4 is a diagram illustrating an example of a business operator information table stored in the business operator information storage unit 41. As illustrated in FIG. 4, the business operator information table includes information such as “identification target ID,” “corporate ID,” “business operator information,” and “type of provision information,” which are associated with one another.

The “identification target ID” is the identification target ID of the identification target 6. In the example of FIG. 4, the identification target IDs of the identification targets 6₁, 6₂, 6₃, and 6₄ are set to “X1”, “X2”, “X3”, and “X4.” The “corporate ID” is identification information on the partner company C. The identification information on the partner companies CA and CB includes “CA” and “CB,” for example.

The “business operator information” is business operator information corresponding to the business operator. Based on the business operator information, information is provided to the user terminal 5. In the example of FIG. 4, the “business operator information” corresponding to the identification target ID “X1” indicates the payment methods A1, B2, and B3 usable at the store A₁ corresponding to the identification target ID “X1.”

The “business operator information” corresponding to the identification target ID “X2” indicates the payment methods A2 and A3 usable at the store A₂ corresponding to the identification target ID “X2.” The payment methods A1, A2, and A3 refer to the types of credit card payment (for example, international brands). The payment methods B2 and B3 refer to the types of e-money payment.

The “business operator information” corresponding to the identification target ID “X3” indicates products P1, P2, and so on sold at the store B₁ corresponding to the identification target ID “X3.” The “business operator information” corresponding to the identification target ID “X4” indicates products P11, P12, and so on sold at the store B₂ corresponding to the identification target ID “X4.”

The “business operator information” is not limited to the payment methods and sold products. For example, the “business operator information” may be information on services provided at the store, limitation on entry into the store (hereinafter, referred to as entry limitation), limitation on purchase of products and services at the store (hereinafter, referred to as purchase limitation) (for example, available only for adults, only for women, or only for residents in the city), or the like.

The “types of provision information” are information indicative of the types of information to be provided to the user terminal 5. For example, the “type of provision information” corresponding to the identification targets IDs “X1,” “X3,” and “X4” is “display information.” The “type of provision information” corresponding to the identification target ID “X2” is “activation information.” The “display information” is information for display at the display unit of the user terminal 5, and the “activation information” is information for activating specific functions of the user terminal 5.

3.2. Detection Information Acquisition Unit

The detection information acquisition unit 52 acquires the detection information transmitted from the user terminal 5, and outputs the same to the business operator information acquisition unit 53 and the user information acquisition unit 54. The detection information acquisition unit 52 also updates the action history in the user information table (for example, information on visits to the store) based on the detection information transmitted from the user terminal 5.

3.3. Business Operator Information Acquisition Unit

The business operator information acquisition unit 53 acquires the business operator information on the business operator at the place corresponding to the identification target ID included in the detection information, from the business operator information table stored in the business operator information storage unit 41.

When the identification target ID “X1” is included in the detection information, for example, the business operator information acquisition unit 53 acquires the information on the payment methods A1, 82, and 33 usable at the store A₁ corresponding to the user-entered place as business operator information. When the identification target ID “X2” is included in the detection information, for example, the business operator information acquisition unit 53 acquires the information on the payment methods A2 and A3 usable at the store A₂ corresponding to the user-entered place as business operator information.

When the identification target ID “X3” is included in the detection information, for example, the business operator information acquisition unit 53 acquires the information on the products P1, P2, sold at the store B₁ corresponding to the user-entered place as business operator information. When the identification target ID “X4” is included in the detection information, for example, the business operator information acquisition unit 53 acquires the information on the products P11, P12, . . . sold at the store B₂ corresponding to the user-entered place as business operator information.

3.4. User Information Acquisition Unit

The user information acquisition unit 54 acquires, among the pieces of user information stored in the user information storage unit 42 and corresponding to the terminal ID included in the detection information, the information corresponding to the business operator information on the business operator corresponding to the identification target ID included in the detection information.

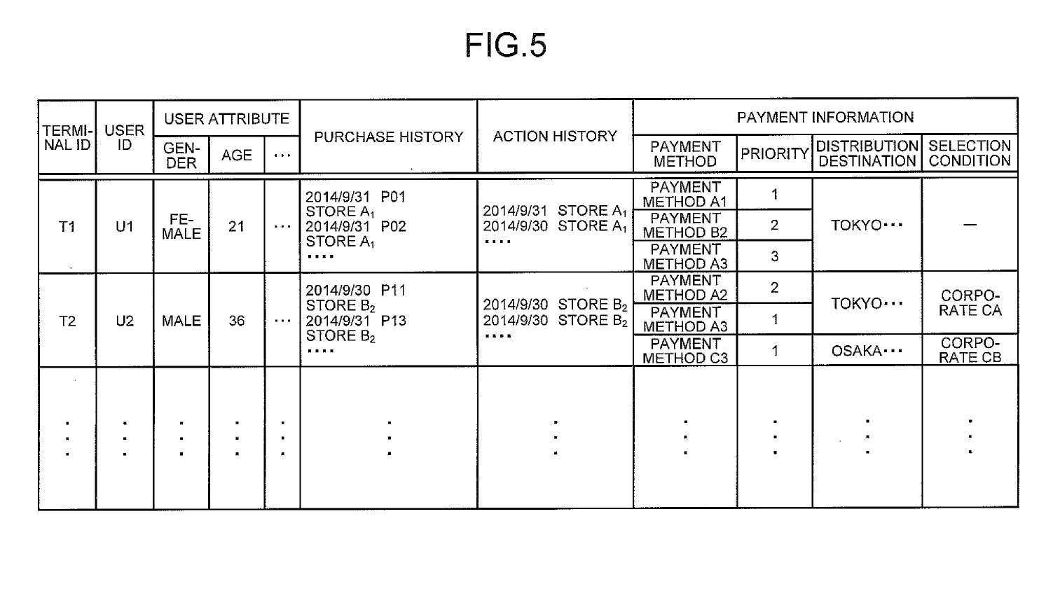

FIG. 5 is a diagram illustrating an example of a user information table stored in the user information storage unit 42. As illustrated in FIG. 5, the user information table includes information such as “terminal ID,” “user ID,” “user attribute,” “purchase history,” “action history,” and “payment information,” which are associated with one another.

The “terminal ID” is identification information on the user terminal 5 having transmitted the detection information and, for example, is the MAC address of the communication unit of the user terminal 5 or unique identification information assigned by an application program in the user terminal 5. In the following description, the terminal IDs of the user terminals 5₁ to 5₅ are designated as “T1” to “T6,” respectively.

The “user ID” is identification information on the user U set by the information provider and, for example, is the login ID for the site server 8 operated by the information provider. When the terminal ID “T1” is included in the detection information, for example, the user information storage unit 42 determines the user ID as “U1.”

The “purchase history” is the history of the user U's purchase of products and services. The purchase history is information acquired from the information management apparatuses 4₁ and 4₂, for example. The “action history” is the history of the user U's visits to the store. The action history is set in the user information table based on the detection information, for example.

The “payment information” is information on payment options available to the user U. The payment information includes information such as “payment method,” “priority,” “distribution destination,” and “selection condition.” The “payment method” is information on the payment methods usable by the user U. The payment methods include, for example, credit card payment, e-money payment, convenience-store payment, and brands for the payment methods.

The “priority” indicates the priorities of the payment methods usable by the user U. For example, for the user U with the user ID “U1,” the priorities of the payment methods A1, B2, and A3 are assigned in decreasing order of A1, 32, and A3.

The “distribution destination” is information on distribution destination of a purchased product and, for example, is the address of the user U's house or company. For the “distribution destination,” different addresses may be set in correspondence with the “payment methods.”

The “selection condition” is a condition for selecting the payment method and the distribution destination. In the example of FIG. 5, when the selection condition is the company CA as business operator information to be acquired, among the payment methods A2, A3, and C3 corresponding to the terminal ID “T2,” the payment methods A2 and A3 are selected, and when the selection condition is the company CB, the payment method C3 is selected. In the business operator information table, as illustrated in FIG. 4, the corporate IDs are associated with the identification target IDs, so that the user information acquisition unit 54 can determine the company C according to the business operator information table.

The “selection condition” is not limited to the business operator at the user-entered place but may be any of various selection conditions. For example, as the “selection condition,” the kinds of products and services provided at the user-entered place, time zone, day of week, region where the user-entered place is located, and the like can be set.

It is here assumed that the business operator table is as illustrated in FIG. 4 and the user information table is as illustrated in FIG. 5. In addition, it is assumed that the user terminal 5 with the terminal ID “T1” has transmitted to the information management apparatus 4 the detection information including the identification target ID of the identification target 6 provided at the store A₁.

In this case, the user information acquisition unit 54 acquires, among the pieces of information on the payment methods A1, B2, and B3 usable at the store A₁, for example, the information on the payment methods A1 and B2 usable by the user U of the user terminal 5 with the terminal ID “T1,” according to the user information table. The user information acquisition unit 54 also acquires the information on the priorities of the payment methods A1 and B2 and the distribution destination.

It is assumed that the user terminal 5 with the terminal ID “T2” has transmitted to the information management apparatus 4 the detection information including the identification target ID of the identification target 6 provided at the store A₂. In this case, the user information acquisition unit 54 acquires, among the pieces of information on the payment methods A1, B2, and B3 usable at the store A₂, for example, the information on the payment method A2 usable by the user U of the user terminal 5 with the terminal ID “T2,” according to the user information table.

It is assumed that the user terminal 5 with the terminal ID “T2” has transmitted to the information management apparatus 4 the detection information including the identification target ID of the identification target 6 provided at the store B₂. In this case, the user information acquisition unit 54 acquires, among the pieces of information on the products P11, P12, P13, . . . sold at the store B₂, for example, the information on the products P11 and P13 purchased in the past by the user U of the user terminal 5 with the terminal ID “T2,” according to the user information stored in the user information storage unit 42.

When the “business operator information” is information indicative of the limitation on entry into the store and limitation on purchase, for example, the user information acquisition unit 54 acquires the information on user attributes relating to entry limitation and purchase limitation, according to the user information stored in the user information storage unit 42. When the target for the entry limitation and the purchase limitation is age, for example, the user information acquisition unit 54 acquires the information on the age of the user U. When the target for the entry limitation and the purchase limitation is gender, for example, the user information acquisition unit 54 acquires the information on the gender of the user U.

3.5. Information Provision Unit

The information provision unit 55 provides information to the user terminal 5 that detects the identification target ID, according to the information acquired by the user information acquisition unit 54.

The kind of information provided by the information provision unit 55 is decided according to the business operator information table, for example. When the business operator information table is as illustrated in FIG. 4, for example, the information provision unit 55 transmits the display information generated according to the information acquired by the user information acquisition unit 54 to the user terminal 5 that detects the identification target ID “X1,” for example. Accordingly, the user U of the user terminal 5 can grasp the information corresponding to the business operator information among the pieces of user information, for example.

The information provision unit 55 transmits the activation information generated according to the information acquired by the user information acquisition unit 54 to the user terminal 5 that detects the identification target ID “X2,” for example. Accordingly, the function of the user terminal 5 according to the information corresponding to the business operator information among the pieces of user information, for example, is activated, which saves the user U from having to activate the function corresponding to the business operator information.

In the case where the “business operator information” indicates that only adults are allowed to enter the store, for example, when determining the user U as an adult based on the information on the age of the user U, for example, the information provision unit 55 generates the display information indicating that the user U is allowed to enter the store and purchase products at the store. In contrast, when not determining the user U as an adult, the information provision unit 55 generates the display information indicating that the user U is not allowed to enter the store or purchase products at the store. The information provision unit 55 transmits the generated display information to the user terminal 5.

When the “business operator information” indicates that only women are allowed to enter the store, for example, when determining the user U as female based on the information on the gender of the user U, for example, the information provision unit 55 generates the display information indicating that the user U is allowed to enter the store and purchase products at the store. In contrast, when not determining the user U as female, the information provision unit 55 generates the display information indicating that the user U is not allowed to enter the store or purchase products at the store. The information provision unit 55 transmits the generated display information to the user terminal 5.

4. User Terminal

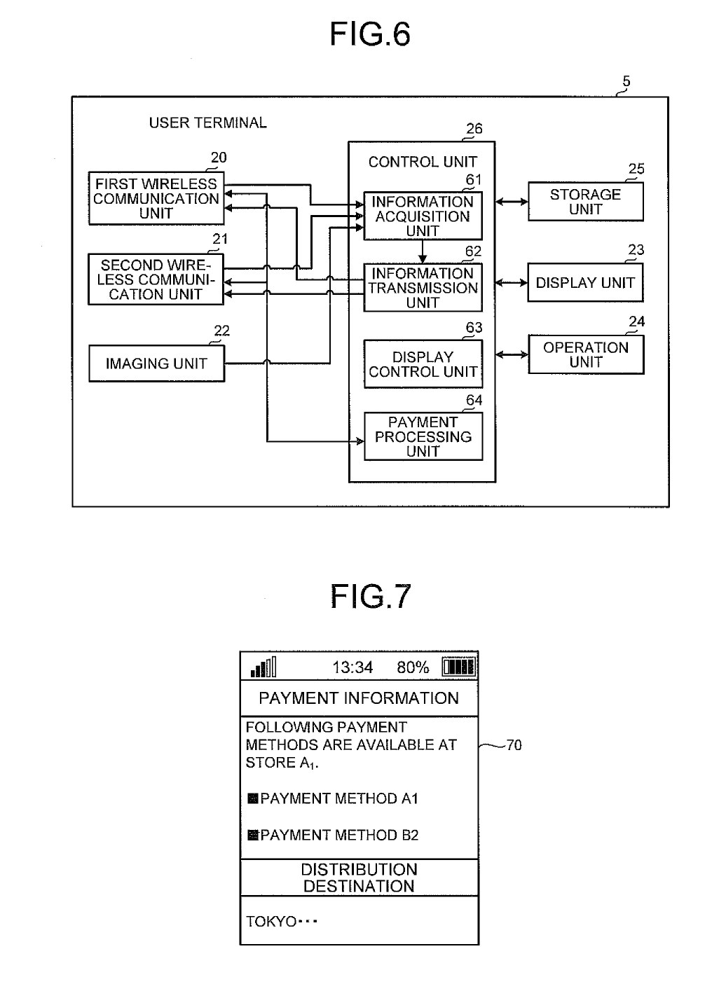

Next, the configuration of the user terminal 5 will be described. FIG. 6 is a diagram illustrating a configuration example of the user terminal 5. As illustrated in FIG. 6, the user terminal 5 has a first wireless communication unit 20, a second wireless communication unit 21, an imaging unit 22, a display unit 23, an operation unit 24, a storage unit 25, and a control unit 26.

The first wireless communication unit 20 is a communication interface that exchanges information with the identification target 6. The second wireless communication unit 21 is a communication interface that exchanges information with a wireless WAN base station (not illustrated). The wireless WAN base station is a wireless base station in a public phone communication network or a wireless base station in a public data communication network, for example.

The imaging unit 22 has a CCD (Charge Coupled Devices) image sensor, a CMOS (complementary MOS) image sensor, and others. The imaging unit 22 takes a shot of the surroundings of the user terminal 5 and outputs obtained image data to the control unit 26.

The display unit 23 is a touch-panel display. The user U of the user terminal 5 can touch the screen of the display unit 23 by a finger or the like to perform an operation on the operation screen displayed at the display unit 23. The display unit 23 is a small-sized LCD (Liquid Crystal Display) or an organic EL display, for example.

The operation unit 24 has a keyboard including keys for entry of characters, numbers, and a space, an enter key, and allow keys, a power button, and others.

The storage unit 25 is a storage device such as a RAM (Random Access Memory), a semiconductor memory device such as a flash memory, or a hard disc, for example. The storage unit 25 stores various programs. The programs stored in the storage unit 25 include an OS (Operating System), application programs acquired from the information provision apparatus 2, and others.

The user terminal 5 includes a reading device not illustrated. The control unit 26 can read an application program from a recording medium via the reading device, and stores the same in the storage unit 25. The recording medium may be an optical disc, a flexible disc, a hard disc, or the like.

The control unit 26 is implemented by an integrated circuit such as an ASIC or an FPGA, for example. The control unit 26 implements or executes the functions or operations of information processing described later by the CPU or the MPU executing the programs stored in the storage unit 25 in an internal RAM not illustrated as a working area.

Specifically, the control unit 26 executes the application programs stored in the storage unit 25 to perform the functions as an information acquisition unit 61, an information transmission unit 62, a display control unit 63, and a payment processing unit 64. The control unit 26 is not limited to the foregoing configuration but may be configured in any other manner as far as the control unit 26 performs information processing described later.

The information acquisition unit 61 acquires the identification target ID of the identification target 6. Specifically, the information acquisition unit 61 acquires the identification information on the identification target 6 output from the identification target 6 via the first wireless communication unit 20.

In the case where the identification target 6 is a wireless LAN access point, the identification target ID of the identification target 6 is an ESS-ID (Extended Service Set Identifier) or a BSS-ID (Basic Service Set Identifier) of the wireless LAN access point. In the case where the identification target 6 is a device for performing Bluetooth (registered trademark) communications, the identification target ID of the identification target 6 is an UUID (universally Unique Identifier), for example. In the case where the identification target 6 is an NFC device, the identification target ID of the identification target 6 is the ID of the NFC device, for example.

In the case where the identification target 6 is a barcode, the information acquisition unit 61 converts image data of the barcode output from the imaging unit 22 into text information, and acquires the text information as the identification target ID of the identification target 6. The information acquisition unit 61 may set predetermined image information identified from the image of the identification target 6 (for example, the entire or one part of the image of the identification target 6) as the identification target ID of the identification target 6.

The information acquisition unit 61 also acquires provision information transmitted from the information provision apparatus 2, in response to transmission of the detection information from the information transmission unit 62, and stores the same in the storage unit 25.

The information transmission unit 62 transmits the detection information including the identification target ID acquired by the information acquisition unit 61 and the terminal ID stored in the storage unit 25 to the information provision apparatus 2 via the first wireless communication unit 20 or the second wireless communication unit 21. In the case where the identification target 6 is a wireless communication device, the detection information also includes information on radio wave strength. The radio wave strength here refers to the radio wave strength of a wireless signal from the identification target 6 received by the first wireless communication unit 20.

The display control unit 63 displays at the display unit 23 information corresponding to the provision information and activation information stored in the storage unit 25. For example, it is here assumed that the business operator information table is as illustrated in FIG. 4 and the user information table is as illustrated in FIG. 5. When the user terminal 5₁ transmits detection information including the identification target ID of the identification target 6₁ provided at the store A₁, a screen 70 as illustrated in FIG. 7 appears at the display unit 23 of the user terminal 5₁. FIG. 7 is a diagram illustrating an example of a display screen of the user terminal 5.

As illustrated in FIG. 7, of the payment methods usable at the store A₁, the information on the payment methods usable by the user U₁ of the user terminal 5₁ is displayed at the display unit 23 of the user terminal 5₁. Accordingly, the user U₁ can easily recognize the payment methods usable at the store A₁. In addition, information on distribution destination is also displayed on the screen 70, which makes it possible to easily inform the distribution destination to the store clerk at the store A₁.

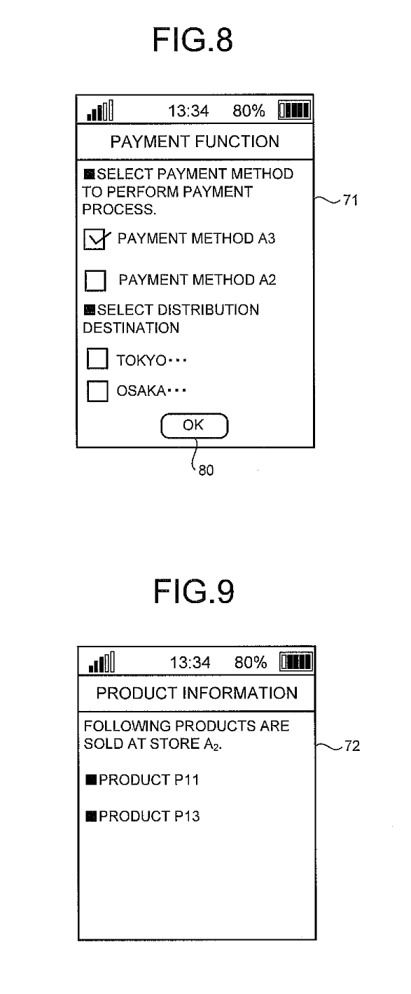

For example, when the user terminal 5₂ transmits detection information including the identification target ID of the identification target 6₂ provided at the store A₂, a screen 71 as illustrated in FIG. 8 appears at the display unit 23 of the user terminal 5₂. FIG. 8 is a diagram illustrating an example of a display screen of the user terminal 5. The screen 71 is displayed according to the activation information and a payment process is performed according to the user U's operation.

The payment methods usable at the store A₂ and usable by the user U₂ of the user terminal 5₂ are the payment methods A2 and A3. As illustrated in FIG. 5, the priority of the payment method A2 corresponding to the user U₂ is “1,” and the priority of the payment method A3 is “2.” Accordingly, the payment method A3 is displayed ahead of the payment method A2 as illustrated in FIG. 8.

On the screen 71 illustrated in FIG. 8, when the user U of the user terminal 5₂ checks the checkbox and presses an OK button 80, the payment processing unit 64 executes the payment process according to the payment method checked in the checkbox. The payment process is conducted by exchange of data with a payment device installed at the store through wireless communications via the second wireless communication unit 21, for example. In the payment process, the payment processing unit 64 may transmit information on the distribution destination transmitted from the information provision apparatus 2 to the device installed at the store via the second wireless communication unit 21.

When the user terminal 5₂ transmits detection information including the identification target ID of the identification target 6₄ provided at the store B₂, a screen 72 as illustrated in FIG. 9 appears at the display unit 23 of the user terminal 5₂. FIG. 9 is a diagram illustrating an example of a display screen of the user terminal 5.

As illustrated in FIG. 9, of the products purchased in the past by the user U₂ of the user terminal 5₂, information on the products corresponding to the products sold at the store B₂ is displayed at the display unit 23 of the user terminal 5₂. Accordingly, the user U₂ can easily ascertain whether the regularly purchased product is sold at the store B₂, for example.

Some or all of the functions of the control unit 32 of the information provision apparatus 2 may be performed within a user terminal 5. Specifically, the control unit 26 of the user terminal 5 may execute one or more of the functions of the information acquisition unit 51, the detection information acquisition unit 52, the business operator information acquisition unit 53, the user information acquisition unit 54, and the information provision unit 55.

For example, the information acquisition unit 51 may operate within the user terminal 5 to acquire from the information provision apparatus 2 the business operator information table or the business operator information stored in the business operator information storage unit 41 of the information provision apparatus 2. The information acquisition unit 51 may store the acquired business operator information table or the business operator information in the storage unit 25. In this case, the storage unit 25 functions as a business operator information storage unit.

The detection information acquisition unit 52 may acquire detection information from an information transmission unit 28 within the user terminal 5. The business operator information acquisition unit 53 may acquire from the business operator information table or the business operator information stored in the storage unit 25, the business operator information on the business operator at the place corresponding to the identification target ID included in the detection information within the user terminal 5.

The user information acquisition unit 54 may operate within the user terminal 5 to acquire, among the pieces of user information stored in the user information storage unit 42 of the information provision apparatus 2 and corresponding to the terminal ID included in the detection information, information corresponding to the business operator information on the business operator corresponding to the identification target ID included in the detection information. The user information acquisition unit 54 may acquire the user information on the user terminal 5 from the information provision apparatus 2 and store the same in the storage unit 25. In this case, the storage unit 25 functions as a user information storage unit, for example. The user information acquisition unit 54 may acquire, among the pieces of user information corresponding to the terminal ID included in the detection information, the information corresponding to the business operator information on the business operator corresponding to the identification target ID included in the detection information from the storage unit 25.

The information provision unit 55 may provide information to the user terminal 5 that detects the identification target ID within the user terminal 5, according to the information acquired by the user information acquisition unit 54.

The control unit 26 of the user terminal 5 may perform some of one or more functions of the information acquisition unit 51, the detection information acquisition unit 52, the business operator information acquisition unit 53, the user information acquisition unit 54, and the information provision unit 55.

5. Process by the Information Provision System

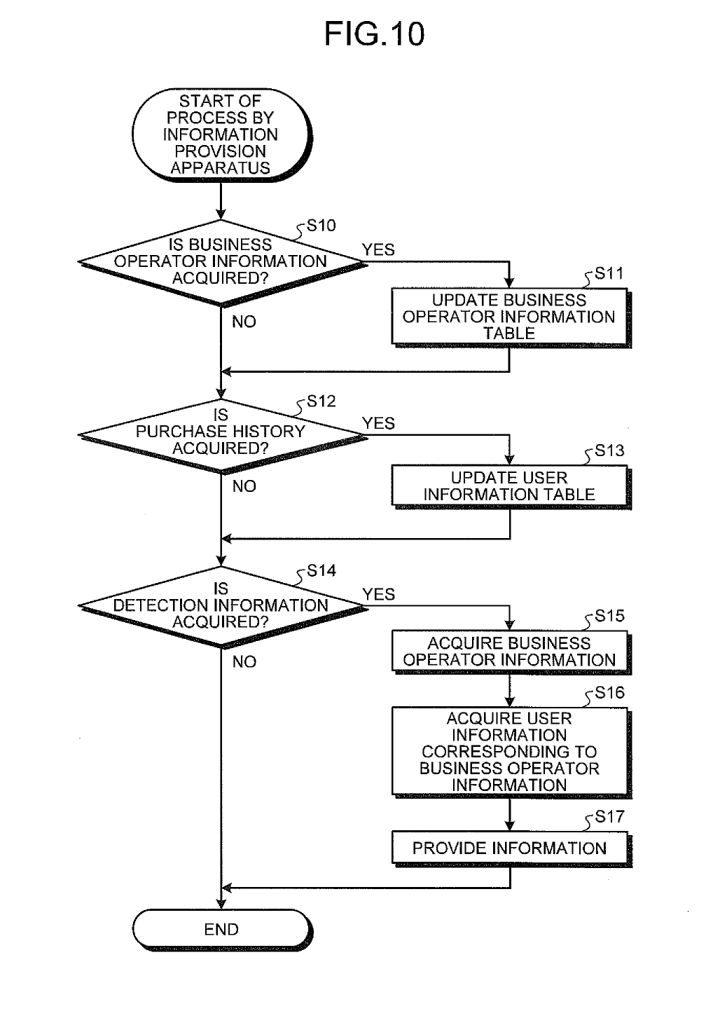

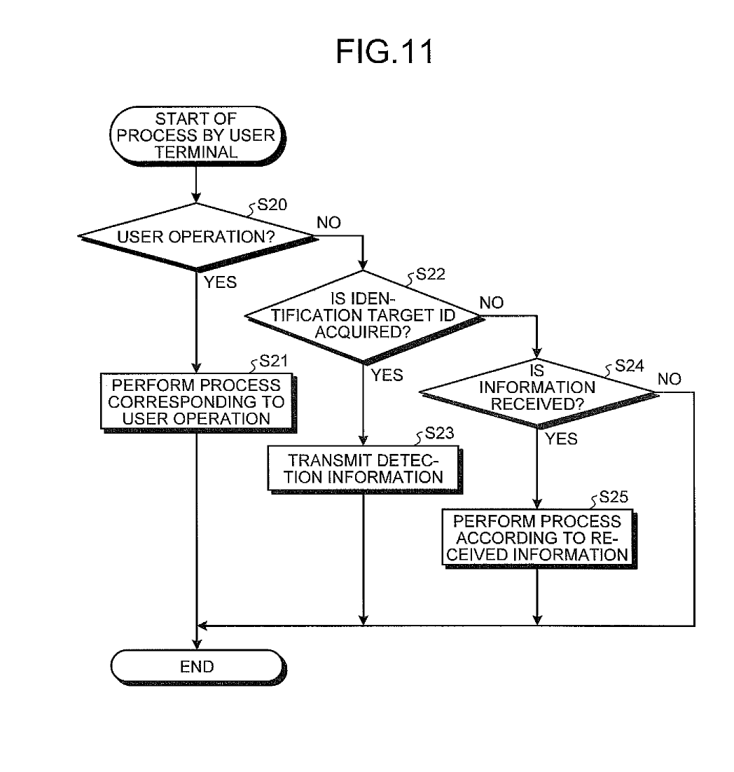

Next, a procedure for an information provision process by the information provision system 1 according to the embodiment will be described. FIGS. 10 and 11 are diagrams for describing a flow of the information provision process by the information provision system 1. Hereinafter, information processing by the information provision apparatus 2 will be described with reference to FIG. 10, and information processing by the user terminal 5 will be described with reference to FIG. 11.

5.1. Process by the Information Provision Apparatus 2

Information processing by the information provision apparatus 2 will be described. FIG. 10 is a flowchart illustrating information processing by the information provision apparatus 2 according to the embodiment. The process is repeatedly executed by the control unit 32 of the information provision apparatus 2.

As described in FIG. 10, the control unit 32 determines whether the business operator information on the partner company C is acquired from the information management apparatus 4 via the communication unit 30 (step S10). When determining that the business operator information on the partner company C is acquired (step S10: Yes), the control unit 32 sets the acquired business operator information in the business operator information table of the business operator information storage unit 41 to update the business operator information table (step S11).

Next, when not determining at step S10 that the business operator information on the partner company C is acquired (step S10: No) or when step S11 is completed, the control unit 32 then determines whether information on the purchase history of the user U at the partner company C is acquired from the information management apparatus 4 via the communication unit 30 (step S12). When determining that information on the purchase history is acquired (step S12: Yes), the control unit 32 sets the acquired purchase history in the user information table of the business operator information storage unit 41 to update the user information table (step S13).

When not determining at step S12 that information on the purchase history is acquired (step S12: No) or when the step S13 is completed, the control unit 32 then determines whether detection information transmitted from the user terminal 5 via the communication unit 30 is acquired (step S14). When determining that the detection information is acquired (step S14: Yes), the control unit 32 acquires the business operator information on the business operator corresponding to the identification target ID included in the detection information (step S15).

Next, the control unit 32 acquires, among the pieces of user information corresponding to the terminal ID included in the detection information, the information corresponding to the business operator information acquired at step S15 (step S16). Then, the control unit 32 provides information to the user terminal 5 having transmitted the detection information, according to the information acquired at step S16 (step S17).

When not determining that the detection information is acquired (step S14: No) or when step S17 is completed, the control unit 32 terminates the process.

5.2. Process by the User Terminal 5

Next, information processing by the user terminal 5 according to the embodiment will be described. FIG. 11 is a flowchart illustrating an example of information processing by the user terminal 5 according to the embodiment. The process is repeatedly executed by the control unit 26 of the user terminal 5.

As illustrated in FIG. 11, the control unit 26 of the user terminal 5 determines whether a user operation is performed (step S20). When determining that a user operation is performed (step S20: Yes), the control unit 26 executes the process according to the user operation (step S21).

When no determining that the user operation is performed (step S20: No), the control unit 26 determines whether the identification target ID is acquired from the identification target 6 (step S22). When determining that the identification target ID is acquired (step S22: Yes), the control unit 26 transmits the detection information including the acquired identification target ID and terminal ID to the information provision apparatus 2 (step S23).

When not determining that the identification target ID is acquired (step S22: No), the control unit 26 then determines whether provision information is received from the information provision apparatus 2 (step S24). When determining that provision information is received (step S24: Yes), the control unit 26 performs a process corresponding to the received information (step S25). When steps S21, S23, and S25 are completed, or when not determining at step S24 that information is received (step S24: No), the control unit 26 terminates the process.

### 6. Modification Example

In the foregoing embodiment, the business operator information is information on stores and business operator as an example. Alternatively, the business operator information may be kinds of point services provided at stores (e.g., companies providing point services or kinds of brands relating to the point services), for example. In this case, the user information includes the kinds of point services used by the user. Accordingly, the control unit 32 can provide to the user terminal 5 the display information and activation information according to the kinds of point services actually used by the user out of point services usable at the stores.

The control unit 32 may also determine whether to provide information based on the action history of the user terminal 5. For example, the control unit 32 may transmit provision information to the user terminal 5 only when the user terminal 5 has transmitted the identification target ID of the identification target 6 provided at a store where the user U has not entered so far. The control unit 32 may also transmit provision information to the user terminal 5 only when the user terminal 5 has transmitted the identification target ID of the identification target 6 provided at a store where the user U visits frequently.

### 7. Hardware Configuration

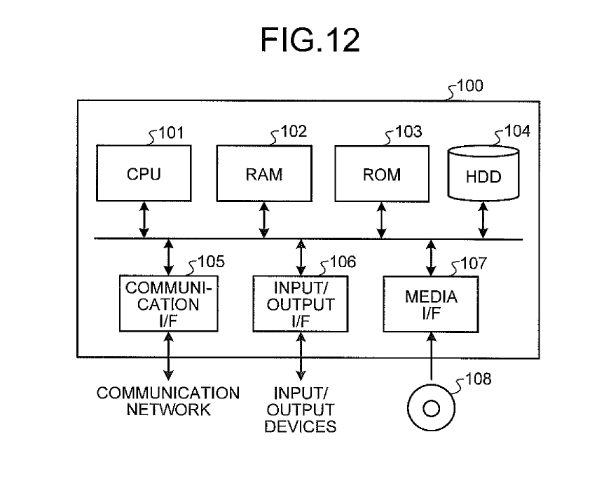

In the embodiment, the information provision apparatus 2 and the user terminal 5 are implemented by a computer 100 configured as illustrated in FIG. 12, for example. FIG. 12 is a hardware configuration diagram illustrating an example of a computer that implements the functions of the information provision apparatus 2 and the user terminal 5.

The computer 100 includes a CPU (Central Processing Unit) 101, a RAM (Random Access Memory) 102, a ROM (Read Only Memory) 103, a HDD (Hard Disk Drive) 104, a communication interface (I/F) 105, an input/output interface (I/F) 106, and a media interface (I/F) 107.

The CPU 101 operates according to the programs stored in the ROM 103 or the HDD 104 to control the components. The ROM 103 stores a boot program to be executed by the CPU 101 at starting of the computer 100, and other programs depending on hardware of the computer 100.

The HDD 104 stores programs to be executed by the CPU 101, data to be used in the programs, and others. The communication I/F 105 corresponds to the communication unit 30, receives data from other devices via the communication network 9 and sends the same to the CPU 101, and transmits data generated by the CPU 101 to other devices via the communication network 9.

The CPU 101 controls output devices such as a display and a printer and input devices such as a keyboard and a mouse via the input/output interface 106. The CPU 101 acquires data from the input devices via the input/output interface 106. The CPU 101 also outputs generated data to the output devices via the input/output interface 106.

The media interface 107 reads a program or data stored in a recording medium 108 and provides the same to the CPU 101 via the RAM 102. The CPU 101 loads the program from the recording medium 108 into the RAM 102 via the media interface 107, and executes the loaded program. The recording medium 108 may be an optical recording medium such as a DVD (Digital Versatile Disc) or a PD (Phase change rewritable Disk), a magneto-optical recording medium such as an MO (Magneto-Optical disk), a tape medium, a magnetic recording medium, or a semiconductor memory.

When the computer 100 functions as the information provision apparatus 2, the CPU 101 of the computer 100 executes a program loaded into the RAM 102 to implement the functions of the control unit 32. The HDD 104 implements the function of the storage unit 31. When the computer 100 functions as the user terminal 5, the CPU 101 of the computer 100 executes a program loaded into the RAM 102 to implement the functions of the control unit 26. The HDD 104 implements the function of the storage unit 25.

The CPU 101 of the computer 100 reads the programs from the recording medium 108 and executes the same. Alternatively, the CPU 101 of the computer 100 may acquire the programs from other devices via the communication network 9.

### 8. Advantages

The information provision apparatus 2 according to the embodiment includes the business operator information storage unit 41, the user information storage unit 42, the detection information acquisition unit 52, the business operator information acquisition unit 53, the user information acquisition unit 54, and the information provision unit. The business operator information storage unit 41 stores business operator information as information on a business operator (for example, partner company C). The user information storage unit 42 stores user information as information on the user of the user terminal 5. The detection information acquisition unit 52 acquires information on the identification target 6 from the user terminal 5 that detects the information on the identification target provided at a place corresponding to the business operator. The business operator information acquisition unit 53 acquires from the business operator information storage unit 41 the business operator information corresponding to the business operator at the place according to the information on the identification target 6 detected by the user terminal 5. The user information acquisition unit 54 acquires, among the pieces of user information stored in the user information storage unit 42 and corresponding to the user terminal 5 that detects the information on the identification target 6, the information corresponding to the business operator information acquired by the business operator information acquisition unit 53. The information provision unit 55 provides information to the user terminal 5 that detects the information on the identification target 6, according to the information acquired by the user information acquisition unit 54.

Accordingly, it is possible to provide the user U with the information suited to the user U according to the place corresponding to the business operator.

The business operator information includes the information indicative of payment methods usable at a place where the identification target 6 is provided. The user information includes the information indicative of payment methods usable by the user U of the user terminal 5. The user information acquisition unit 54 acquires, among the payment methods usable by the user U of the user terminal 5, the information on the payment methods that are identical with the payment methods usable at the place where the identification target 6 is provided.

Accordingly, the user terminal 5 can display, among the payment methods usable by the user U, the information indicative of the payment methods usable at a store of a business operator where the user U has entered, for example.

The user information includes the information on conditions for selection of payment methods usable by the user of the user terminal 5. The user information acquisition unit 54 acquires, among the payment methods usable by the user of the user terminal 5, the information on the payment methods that are identical with the payment methods usable at the place where the identification target 6 is provided and satisfying the conditions for selection.

Accordingly, the user terminal 5 can display, among the payment methods usable by the user U, the information indicative of the payment methods usable at the store of the business operator where the user U has entered and satisfying the conditions for selection, for example.

The information provision unit 55 generates the information for displaying the payment methods at the user terminal 5 according to the information acquired by the user information acquisition unit 54, and provides the same as provision information for the user terminal 5, to the user terminal 5 that detects the information on the identification target 6.

Accordingly, the user terminal 5 can display, among the payment methods usable by the user U, the information indicative of the payment methods usable at the store of the business operator where the user U has entered, for example.

The information provision unit 55 generates the information for activation of the payment function included in the user terminal 5 according to the information acquired by the user information acquisition unit 54, and provides the same as provision information for the user terminal 5, to the user terminal 5 that detects the information on the identification target 6.

Accordingly, when the user terminal 5 has the payment function, for example, the user terminal 5 can activate dynamically the payment function at the user-entered place.

The user information also includes the information on product distribution destinations according to the payment methods usable by the user U of the user terminal 5. The user information acquisition unit 54 acquires from the user information storage unit the information on the product distribution destinations as provision information for the user terminal 5.

Accordingly, the user U can easily inform the distribution destination to a store clerk at the store of the user-entered place, for example.

### 9. Others

Some of embodiments of the present disclosure have been described so far in detail with reference to the drawings. However, these embodiments are mere examples. The present invention can be carried out not only in the aspects described above in the disclosure of the invention section but only in other embodiments with various modifications or improvements according to the knowledge of persons skilled in the art.

The information provision apparatus 2 may be flexibly changed in configuration so as to be implemented by a plurality of server computers or by invoking an external platform or the like via an API (Application Programming Interface) or network computing depending on some functions.

According to one aspect, it is possible to provide an information provision apparatus, an information provision method, and an information provision program that make it possible to provide information suited to users according to places corresponding to business operators.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information provision apparatus comprising:
a business operator information storage unit configured to store pieces of business operator information as information on a business operator;
a user information storage unit configured to store pieces of user information as information on a user of a user terminal;
a detection information acquisition unit configured to acquire information on an identification target provided at a place corresponding to the business operator from the user terminal that detects the information on the identification target;
a business operator information acquisition unit configured to acquire, from the business operator information storage unit, business operator information corresponding to the business operator associated with the place corresponding to the information on the identification target detected by the user terminal;
a user information acquisition unit configured to acquire, among the pieces of user information stored in the user information storage unit and corresponding to the user terminal that detects the information on the identification target, user information corresponding to the business operator information acquired by the business operator information acquisition unit; and
an information provision unit configured to provide information to the user terminal that detects the information on the identification target, based on the user information acquired by the user information acquisition unit.

2. The information provision apparatus according to claim 1, wherein
the business operator information includes information indicative of payment methods usable at the place at which the identification target is provided,
the user information includes information indicative of payment methods usable by the user of the user terminal, and
the user information acquisition unit acquires, among the payment methods usable by the user of the user terminal, information on a payment method that is usable at the place at which the identification target is provided.

3. The information provision apparatus according to claim 2, wherein
the user information includes information on conditions for selection of the payment methods usable by the user of the user terminal, and
the user information acquisition unit acquires, among the payment methods usable by the user of the user terminal, a payment method that is usable at the place at which the identification target is provided and that satisfies the conditions for selection.

4. The information provision apparatus according to claim 2, wherein the information provision unit generates information for displaying the payment method on the user terminal based on the information acquired by the user information acquisition unit, and provides, as provision information for the user terminal, the generated information to the user terminal that detects the information on the identification target.

5. The information provision apparatus according to claim 2, wherein the information provision unit generates information for activating a payment function included in the user terminal based on the information acquired by the user information acquisition unit, and provides, as provision information for the user terminal, the generated information to the user terminal that detects the information on the identification target.

6. The information provision apparatus according to claim 2, wherein
the user information includes information on product distribution destinations according to the payment methods usable by the user of the user terminal, and
the user information acquisition unit further acquires from the user information storage unit the information on the product distribution destinations as provision information for the user terminal.

7. An information provision method executed by a computer, comprising:
acquiring information on an identification target provided at a place corresponding to a business operator from a user terminal that detects the information on the identification target;
acquiring, from a business operator information storage unit that stores pieces of business operator information as information on a business operator, business operator information corresponding to the business operator associated with the place corresponding to the information on the identification target detected by the user terminal;
acquiring, among pieces of user information stored in a user information storage unit and corresponding to the user terminal that detects the information on the identification target, user information corresponding to the acquired business operator information; and
providing information to the user terminal that detects the information on the identification target, based on the acquired user information.

8. A non-transitory computer readable storage medium containing program instructions for providing information, wherein execution of the program instructions by one or more processors of a computer system causes the one or more processors to perform:
acquiring information on an identification target provided at a place corresponding to a business operator from a user terminal that detects the information on the identification target;
acquiring, from a business operator information storage unit that stores pieces of business operator information as information on a business operator, business operator information corresponding to the business operator associated with the place corresponding to the information on the identification target detected by the user terminal;
acquiring, among pieces of user information stored in a user information storage unit and corresponding to the user terminal that detects the information on the identification target, user information corresponding to the acquired business operator information; and
providing information to the user terminal that detects the information on the identification target, based on the acquired user information.
